(19) United States
(12) Patent Application Publication
(10) Pub. No.: US 2006/0158279 A1
(43) Pub. Date: Jul. 20, 2006

(54) Non-reciprocal circuit device

(75) Inventor: Tsuyoshi Kinoshita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/300,406

(22) Filed: Dec. 15, 2005

(30) Foreign Application Priority Data
Dec. 16, 2004 (JP) 2004-364696

(51) Int. Cl. H01P 1/36

(52) U.S. Cl. 333/24.2

(57) ABSTRACT

A non-reciprocal circuit device is provided with a remarkably smaller size than before and can form a sufficiently large filet and improve reliability of soldering strength at mounting. A gyromagnetic component, a permanent magnet, yokes are included. The permanent magnet is provided at least on one face side of the gyromagnetic component and applies a DC magnetic field to the gyromagnetic component. The yoke provides a magnetic path for the magnetic field generated by the permanent magnet. The supporting substrate has one face side which the permanent magnet and the gyromagnetic component are supported on, and the supporting substrate is provided with recess grooves formed at a distance from each other on a side face of the supporting substrate. The inner surface of the recess groove having a conductor electrically connected at least to a center conductor of the gyromagnetic component so as to constitute a terminal part.

### BACKGROUND OF THE INVENTION

1. Field of the Invention

The present invention relates to a non-reciprocal circuit device, such as an isolator or a circulator.

2. Description of Related Art

Non-reciprocal circuit devices such as isolators or circulators are used in mobile wireless equipments such as cellular phones. This type of non-reciprocal circuit device is constituted by, as represented by JP-A-11-205011 and JP-A-11-97910, accommodating magnetic parts such as a gyromagnetic component constituted by a soft magnetic substrate, a central electrode, etc. and electric parts such as a matching capacitor, a terminating resistor and so on in a magnetic metal casing serving as a yoke.

The soft magnetic substrate is combined with the central electrode and a DC magnetic field is applied from the permanent magnet. The central electrode includes a plurality of center conductors, and one end is disposed on one surface of the soft magnetic substrate so as to be grounded as a ground portion on the metal case. The center conductors are disposed on the other surface of the soft magnetic substrate so as to be insulated while crossing one another at a predetermined angle and the front end serves as an external terminal.

To each of the center conductors, a matching capacitor is connected. When used as an isolator, a terminating resistor is further connected to one center conductor which is not connected to an input/output terminal.

The input/output terminal for the center conductor and the ground terminal are constituted by metal terminals embedded in an insulated portion of the case and exposed outside of the case, and the metal terminals are directly soldered and fixed to a conductor pattern of a circuit substrate.

This type of non-reciprocal circuit device is faced with demand for miniaturization as much as possible from its marketability, and as a means for responding the demand is, as disclosed in JP-A-11-205011 and JP-A-11-97910, for example, a structure in which a square-shaped soft magnetic substrate is used instead of a circular soft magnetic substrate and this is accommodated in a case having a square-shaped inner space for accommodating a capacitor, a terminating resistor, etc. with high density utilizing the space between the soft magnetic substrate and the inner wall surface of the case.

However, as the case is miniaturized, the area of the metal terminal has to be reduced, and a fillet with a sufficient area and volume is not formed at mounting on a circuit board, which leads to a fear that soldering strength is not sufficient at mounting.

Moreover, the metal terminal is generally obtained by cutting a lead frame and is restricted by the lead frame and the shape suitable for soldering can not be arbitrarily selected. Also, there remains a so-called burr on the cut surface, which might cause deterioration of reliability.

JP-A-11-205011 and JP-A-11-97910 are based on embedment of the metal terminal constituting an input/output terminal or a ground terminal in a case, and a solution for a problem accompanying the metal terminal when the non-reciprocal circuit device is miniaturized is not disclosed.

### SUMMARY OF THE INVENTION

An object of the present invention is to provide a non-reciprocal circuit device with a remarkably smaller size.

Another object of the present invention is to provide a non-reciprocal circuit device which can improve reliability of soldering strength at mounting by forming a sufficiently large fillet even if the size is reduced.

In order to solve the above problem, the non-reciprocal circuit device according to the present invention comprises a gyromagnetic component, a permanent magnet, a supporting substrate and a yoke. The permanent magnet is provided at least on one face side of the gyromagnetic component and applies a DC magnetic field to the gyromagnetic component. The supporting substrate has one face side which the permanent magnet and the gyromagnetic component are supported on. The yoke provides a magnetic path for the magnetic field generated by the permanent magnet.

This constitution is common to conventional non-reciprocal circuit devices. The present invention is characterized in that the supporting substrate is provided with recess grooves formed at a distance from each other on a side face of the supporting substrate, the inner surface of the recess groove having a conductor electrically connected at least to a center conductor of the gyromagnetic component so as to constitute a terminal part, and the yoke is led through a side face different from said side face of the supporting substrate, that is, the side face on which the recess grooves are formed.

As mentioned above, the yoke is led through the side face different from the side face of the on which the recess grooves of the supporting substrate are provided, which results in the entire structure assembled by the yoke. A case which has been considered as indispensable is not provided. According to this structure, miniaturization is enabled without being restricted by a case.

Based on the premise of the structure without a case, the supporting substrate has a plurality of recess grooves provided with an interval, and at least a conductor electrically conductive to the center conductor of the above gyromagnetic component is applied on the inner surface of the recess groove to constitute a terminal portion. Therefore, at least electric continuity to the center conductors of the gyromagnetic component can be performed through the conductor provided inside the recess groove.

Moreover, the conductor to which the center conductor of the gyromagnetic component is connected is provided on the inner surface of the recess groove, and the surface area is expanded. Therefore, even if being miniaturized, a sufficiently large fillet can be formed at mounting onto the circuit board utilizing the conductor with the expanded surface area, and reliability of soldering strength can be improved.

Preferably, the supporting substrate has a recess portion through which the yoke is led, and the recess portion is formed on the face of the supporting substrate opposite to the face which the gyromagnetic component and the permanent magnet are supported on. According to this structure, by appropriately setting the depth of the recess portion in which the yoke is placed, the lower face of the yoke is aligned with the lower face of the protruded portion with the recess groove provided so as to ensure stability at mounting.

Preferably, the permanent magnet has two opposite side faces that form part of the exterior face, in other words, the two opposing side faces of the permanent magnet is constructed to be exposed on the two opposing side faces of the non-reciprocal circuit device. In case of this structure, the width dimension of the permanent magnet determines the width dimension of the non-reciprocal circuit device as a whole. Thus, miniaturization becomes possible.

As mentioned above, according to the present invention, the following effects can be obtained:
(a) A non-reciprocal circuit device whose size is remarkably reduced can be provided.
(b) A non-reciprocal circuit device which can improve reliability of soldering strength at mounting can be provided by forming a sufficiently large fillet even after being miniaturized.

### BRIEF DESCRIPTION OF THE DRAWINGS

FIG. 1 is an exploded perspective view showing a preferred embodiment of a non-reciprocal circuit device according to the present invention.

FIG. 2 is a perspective view of the non-reciprocal circuit device shown in FIG. 1 in the assembled state.

FIG. 3 is a perspective view of a gyromagnetic component.

FIG. 4 is an exploded perspective view showing another preferred embodiment of the non-reciprocal circuit device according to the present invention.

### DETAILED DESCRIPTION OF THE PREFERRED EMBODIMENTS

Other purposes, constitution and advantages of the present invention will be described in more detail referring to the attached drawings. However, the attached drawings are shown only for illustrating purpose.

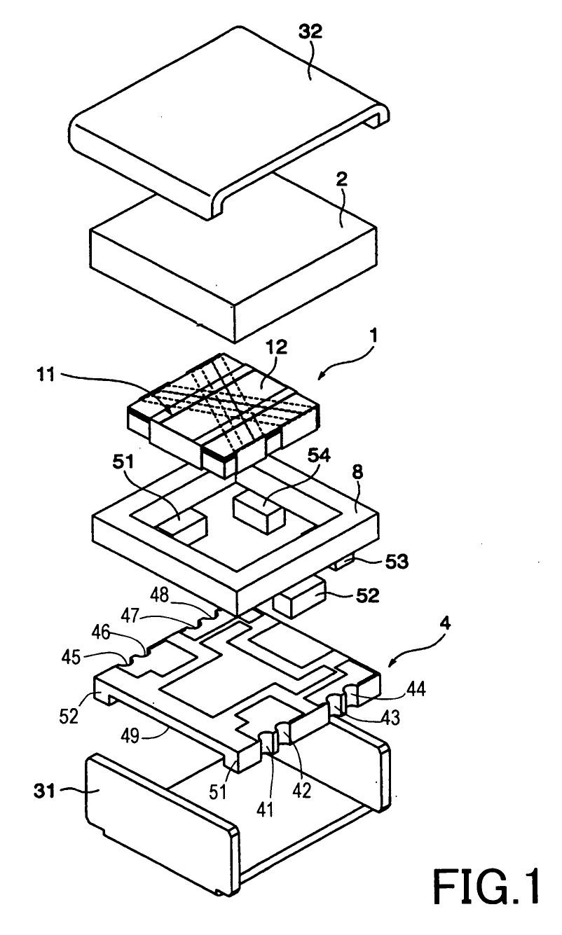

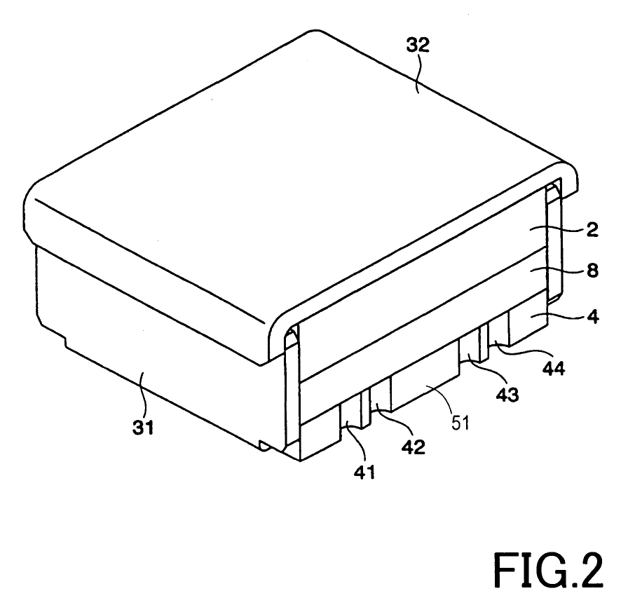

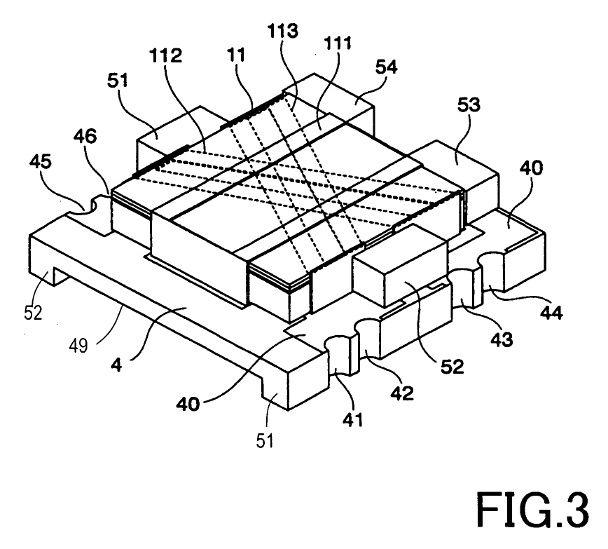

FIG. 1 is an exploded perspective view showing a preferred embodiment of a non-reciprocal circuit device according to the present invention, FIG. 2 is a perspective view of the non-reciprocal circuit device shown in FIG. 1 in the assembled state, and FIG. 3 is a perspective view of a gyromagnetic component. Figs. show an example of an isolator.

The illustrated non-reciprocal circuit device has a gyromagnetic component 1, a permanent magnet 2, a first yoke 31, a second yoke 32 and a supporting substrate 4. In the preferred embodiment, it further has capacitors 51, 52 and a terminating resistor 53.

The gyromagnetic component 1 includes, as shown in FIG. 3, a central electrode 11 and a soft magnetic substrate 12. The central electrode 11 includes first to third center conductors 111 to 113. The first to third center conductors 111 to 113 are branched from 3 sides of an approximately square-shaped ground portion in contact with the lower surface of the soft magnetic substrate 12. The first to the third center conductors 111 to 113 are provided through insulating bodies so that they cross each other on the main surface of the soft magnetic substrate 12 at a predetermined angle. The third center conductor 113 located on the lowermost side is formed on an insulating body 114 provided on the soft magnetic substrate 12.

As the soft magnetic substrate 12, a soft magnetic material (ferrite) such as yttrium/iron/garnet (YIG) is preferable. The shape of the soft magnetic substrate is not limited, but it is preferably a square.

The permanent magnet 2 is to apply a DC magnetic field to the gyromagnetic component 1 and is provided on one face side of the gyromagnetic component 1 in the preferred embodiment. However, it may be provided on both faces of the gyromagnetic component 1.

The first yoke 31 and the second yoke 32 constitute a magnetic path with respect to the magnetic field generated by the permanent magnet 2. It is needless to say that the first yoke 31 and the second yoke 32 are made of a magnetic material. The first yoke 31 and the second yoke 32 in the preferred embodiment are made by bending process of a magnetic metal plate.

The first yoke 31 is led through the side faces different from the both side faces to which the side face of the permanent magnet 2 is exposed, that is, the side faces in the lengthwise direction. The second yoke 32 is superimposed on the permanent magnet 2. And the both ends are joined to the first yoke 31 so as to constitute the magnetic path with respect to the magnetic field generated by the permanent magnet 2. The fixed connection between the first yoke 31 and the second yoke 32 can be realized by mechanical connection or connection using solder or the like.

The supporting substrate 4 has a conductor pattern 40 formed with a predetermined pattern for connecting the capacitors 51, 52, terminating resistors 53, 53 and center conductors 111 to 113. Also, recess grooves 41 to 48 are provided on the side faces of the supporting substrate 4, and a conductor continuing to the conductor pattern 40 is applied to the inner faces of the recess grooves 41 to 48 so as to constitute a terminal portion. The conductor is preferably a conductor film. That is because the expanded surface area of the recess grooves 41 to 48 can be utilized as it is so as to form a conductor with expanded surface area.

The recess grooves 41, 42 among the recess grooves 41 to 48 are used as input terminals, the recess grooves 43, 44, 47, 48 as ground terminals and the recess grooves 45, 46 as output terminals, for example.

The side faces of the supporting substrate 4 on which the recess grooves 41 to 48 are provided match the both side faces to which the side faces of the permanent magnet 2 is exposed. Therefore, the first yoke 31 and the second yoke 32 are led through the side faces different from the side faces on which the recess grooves 41 to 48 of the supporting substrate 4 are provided and they restrict the entire structure.

As mentioned above, since the first yoke 31 and the second yoke 32 are led through the side faces different from the side faces on which the recess grooves 41 to 48 of the supporting substrate 4 are provided and they restrict the entire structure, the entire structure is assembled by the first yoke 31 and the second yoke 32. The case which has been considered as indispensable is not provided. According to this structure, miniaturization is enabled without being restricted by a case.

Based on the premise of the structure without a case, the supporting substrate 4 has a plurality of recess grooves 41 to 48 provided with an interval on the side faces, and at least a conductor electrically conductive to the first to third center conductors 111 to 113 of the gyromagnetic component 1 is applied inside the recess grooves 41 to 48. Therefore, at least electric continuity to the center conductors of the gyromagnetic component 1 can be performed through the conductor provided inside the recess grooves 41 to 48.

Moreover, the conductor to which the first to third center conductors 111 to 113 of the gyromagnetic component 1 are connected is located inside the recess grooves 41 to 48 and the surface area is expanded. Therefore, even if miniaturized, a sufficiently large fillet can be formed at mounting onto the circuit board utilizing the conductor on the inner faces of the recess grooves 41 to 48 with expanded surface area, and reliability of soldering strength can be improved.

In the preferred embodiment, the supporting substrate 4 has a recess portion 49 through which the first yoke 31 is passed on the face opposite to the face on which the gyromagnetic component 1 and the permanent magnet 2 are loaded. In this case, the recess grooves 41 to 48 are provided on the protruded portions 51, 52 outside the recess portion 49. According to this structure, by appropriately setting the depth of the recess portion 49 in which the first yoke 31 is placed, the lower face of the first yoke 31 is aligned with the lower faces of the protruded portions 51, 52 with the recess grooves 41 to 48 provided so as to ensure placement stability at mounting.

The outer shape of the gyromagnetic component 1 shown in the preferred embodiment is smaller than the permanent magnet 2. If the outer shape of the gyromagnetic component 1 is smaller than the permanent magnet 2, a space is generated between the gyromagnetic component 1 and the permanent magnet 2 due to the outer shape difference. This space is preferably filled by an insulating resin 8. By this, reliability is improved.

Moreover, in the preferred embodiment, the outer shape of the supporting substrate 4 is matched with the permanent magnet 2. The supporting substrate 4 has almost the same outer shape as that of the permanent magnet 2, and when the gyromagnetic component 1 is disposed above the supporting substrate 4, a space is generated between the outer circumference of the gyromagnetic component 1 and the outer circumference of the supporting substrate 4 due to the outer shape difference between the both. The capacitors 51, 52 and the terminating resistor 53 are disposed in the above space and fixed to the conductor pattern formed on the supporting substrate 4 by soldering or the like and also fixed to a predetermined one of the center conductors 111 to 113 by means of soldering or the like so as to have a known circuit configuration. And the periphery is filled with the insulating resin 8. As shown in FIG. 1, the entire space need not be filled but only the exposed face may be filled with the insulating resin 8.

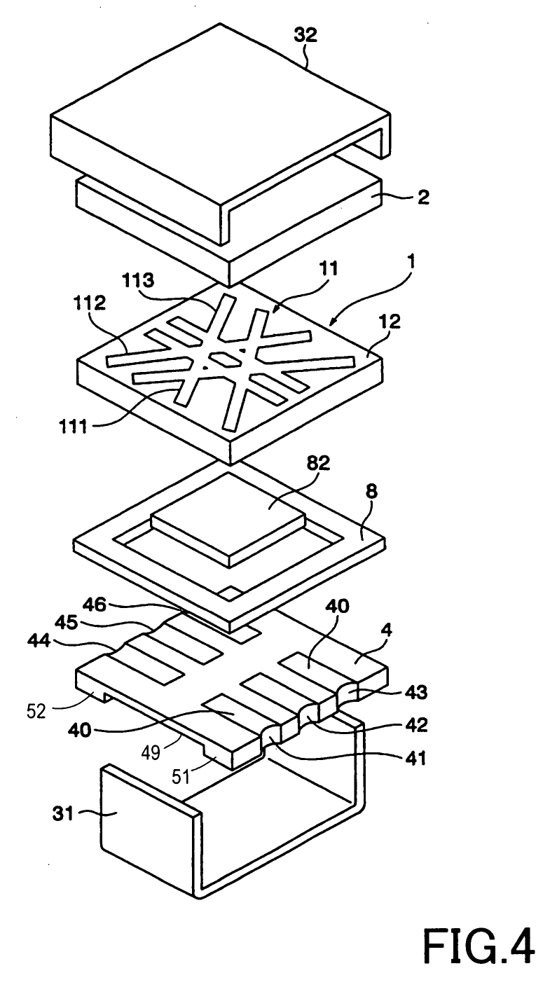

FIG. 4 is an exploded perspective view showing a preferred embodiment of a non-reciprocal circuit device according to the present invention. In this Fig., the same reference numerals are given to the portions corresponding to constituent portions appearing on FIGS. 1 to 3 so as to omit duplicated description. The preferred embodiment shown in FIG. 4 is characterized by the construction of the gyromagnetic component 1. That is, the gyromagnetic component 1 has the central electrode 11 formed as a conductor film on one face of the soft magnetic substrate 12. The center conductors 111 to 113 constituting the central electrode 11 are formed on one face of the soft magnetic substrate 12 with being insulated from one another with an inorganic or organic insulating film. For derivation of the center conductors 111 to 113, the through-hole technology or the like can be applied.

The gyromagnetic component 1 is joined to the supporting substrate 4 through a functional substrate 82 including a capacitor and a terminating resistor required for circuit configuration. At that time, as mentioned above, a space may be filled with the adhesive resin 8. It is not necessary to fill all the spaces but only the exposed face may be filled with the insulating resin 8. Also, the above-mentioned insulating resin 8 may have an adhesive function. In this case, the fixation strength between components such as the permanent magnet 2, supporting substrate 4, gyromagnetic component 1 or the like can be increased.

In this preferred embodiment, too, the first yoke 31 and the second yoke 32 and the supporting substrate 4 are provided with all the characteristics of the present invention. Fist, the first yoke 31 and the second yoke 32 are led through the side faces different from the side faces on which the recess grooves 41 to 48 of the supporting substrate 4 are provided and they restrict the entire structure. Therefore, miniaturization is enabled without being restricted by a case.

In the supporting substrate 4, the conductor to which the first to third center conductors 111 to 113 of the gyromagnetic component 1 are connected is located inside the recess grooves 41 to 48, and the surface are is expanded. Therefore, even if being miniaturized, a sufficiently large fillet can be formed at mounting onto the circuit board utilizing the conductor on the inner face of the recess grooves 41 to 48 with the expanded surface area, and reliability of soldering strength can be improved.

The present invention has been described above in detail referring to the preferred embodiments, but the present invention is not limited to them but it is obvious that those skilled in the art can come up with various variations based on the basic technical idea and instructions.

What is claimed is:

1. A non-reciprocal circuit device including a gyromagnetic component, a permanent magnet, a supporting substrate and a yoke, wherein:
said permanent magnet is provided at least on one face side of said gyromagnetic component and applies a DC magnetic field to said gyromagnetic component;
said supporting substrate has one face side which said permanent magnet and said gyromagnetic component are supported on, and the supporting substrate is provided with recess grooves formed at a distance from each other on a side face of the supporting substrate, the inner surface of said recess groove having a conductor electrically connected at least to a center conductor of said gyromagnetic component so as to constitute a terminal part; and
said yoke provides a magnetic path for the magnetic field generated by said permanent magnet and is led through a side face different from said side face of said supporting substrate.

2. A non-reciprocal circuit device in claim 1, wherein said supporting substrate has a recess portion through which said yoke is led, and the recess portion is formed on the face of the supporting substrate opposite to the face which said gyromagnetic component and said permanent magnet are supported on.

3. A non-reciprocal circuit device in claim 1, wherein said permanent magnet has two opposite side faces that form part of the exterior face.

4. A non-reciprocal circuit device in claim 2, wherein said permanent magnet has two opposite side faces that form part of the exterior face.
